(19) United States
(12) Patent Application Publication
(10) Pub. No.: US 2013/0273333 A1
(43) Pub. Date: Oct. 17, 2013

(54) ADHESIVE TAPE AND TUBE CASING PRODUCED FROM THE ADHESIVE TAPE

(71) Applicants: Thorsten Meier, Duesseldorf (DE); Daniela Tenbusch, Wuppertal (DE)

(72) Inventors: Thorsten Meier, Duesseldorf (DE); Daniela Tenbusch, Wuppertal (DE)

(73) Assignee: CERTOPLAST VORWERK & SOHN GmbH, Wuppertal (DE)

(21) Appl. No.: 13/876,535

(22) PCT Filed: May 11, 2011
(86) PCT No.: PCT/EP2011/057620

§ 371 Date: May 14, 2013

(30) Foreign Application Priority Data
Oct. 14, 2010 (DE) 20 2010 014 239.3

(51) Int. Cl. H01B 7/00; C09J 7/04

(52) U.S. Cl. CPC H01B 7/0045; C09J 7/04
USPC 428/189; 428/377

(57) ABSTRACT

The present invention relates to an adhesive tape, in particular a wrapping tape for bundling cables (1) in automobiles. The basic design comprises a tape-shaped carrier (3) and at least one adhesive strip (4; 4a, 4b) that is applied to at least one side of the carrier (9). According to the invention, the adhesive strip (4; 4a, 4b) covers between 20% and 50% of the area of the associated carrier side (3a, 3b).

The invention relates to an adhesive tape, in particular, a wrapping tape for binding cables in automobiles, comprising a backing band and at least one adhesive strip applied to at least one face of the backing.

An adhesive tape of the above-described construction, as is described within the broadest possible meaning in DE 101 28 078, relates to a self-adhesive sealing sheeting that is employed in the construction industry, and, in particular, in connection with facades. This sheeting has a strip-like sealing adhesive that extends over the entire length of the sealing sheeting, the adhesive being applied to a first adhesive zone. In addition, a second adhesive zone is created. The purpose here is to ensure a lasting, clean and simple installation of the sealing sheeting.

In addition, the prior art deals analogously, for example, EP 1 448 744 [US 2004/0253889], with an adhesive tape that is advantageously used as wrapping tape for binding cables in automobiles. The known adhesive tape has a full-coverage adhesive coating that is applied on one or both faces of the backing. No reference is made here to an adhesive strip that covers the backing only partially.

The prior art has in principle proved successful in terms of the described areas of application. There is, however, need for improvement of the teaching of EP 1 448 744 in that the known adhesive tape at least partially adheres to the cables when creating a spiral-shaped wrap of cables in automobiles. As a result, the entire wrapped cable set is negatively affected in terms of its flexibility, a factor that is disadvantageous in certain applications within an automobile. The invention is intended to provide a remedy here.

The object of the invention is to further develop an adhesive tape of this type so as to successfully provide an especially flexible wrapping of objects to be combined together, in particular, cables.

To attain this object, a generic adhesive tape within the scope of the invention is characterized in that the adhesive strip covers between approximately 20% and 50% of the surface of the associated backing face. The adhesive strip preferably occupies between approximately 30% and approximately 40% of the surface of the backing face.

It has furthermore proven advantageous in this regard for the adhesive strip extend longitudinally and along the edge of the backing. This then enables the adhesive strip to be very easily applied to the backing - specifically, starting at one edge of the backing and toward the center of the backing. This can be effected by an appropriately designed doctor-blade application or other coating methods. In principle, however, the adhesive strip can also be set a certain distance away from both edges of the backing, and run more or less along the center of the backing. In general, however, the preferred approach is to locate the adhesive strip on one edge of the backing for reasons that will be explained below.

In addition, it has proven advantageous for two adhesive strips to be provided. The working mode here is usually to have one adhesive strip of the two adhesive strips applied to or defined on the upper face of the backing. Conversely, the other of the two adhesive strips is located on the lower face of the backing. This then provides the ability to locate the two adhesive strips on the same edge. Consequently, the two adhesive strips overlap each other in terms of the cross-section of the adhesive tape.

In an especially preferred variant, however, the two adhesive strips extend from opposite edges. In this case, there is no overlap between the two adhesive strips in the cross-section of the adhesive tape. The two adhesive strips that are on opposite edges and on different faces of the backing instead delimit between them a free region of the backing in the cross-section of the adhesive tape. This free region of the backing is free of adhesive. In addition, the free region is advantageously of mirror-symmetrical design, specifically, relative to a longitudinal axis of the tape.

The two adhesive strips on the same edge or on opposite edges have the same uniform width. They are furthermore advantageously produced from the same adhesive material, and thus have identical or similar properties of adhesion.

The backing is advantageously a fabric backing, although it is in principle also possible to employ other backings, such as, for example, a nonwoven or similar fabric material composed of fibers, in particular, artificial fibers. The backing in any case advantageously has a surface that at least in certain regions is smooth-polished on one face or both faces. The upper face and the lower face generally are each designed to be smooth-polished over the entire surface, and have a continuous smooth-polished surface. The smooth-polished surface may be chintzed, as is described in detail in connection with EP 1 448 744 as referenced above.

This approach enables a compacted tape surface or backing surface to be revealed that is designed to be highly dirt-repellant. Utilizing a fabric backing, and, in particular, a polyester fabric backing furthermore enables excellent resistance to media to be provided, such as, for example, to oil, gasoline, etc.—an aspect that is of particular importance for the specific intended application of binding automobile cables, for example, in the engine compartment. In addition, the adhesive tapes with these fabric backings can be relatively easily torn by hand—an aspect that is also of particular importance for the described intended application and for the especially preferred utilization as wrapping tape for binding automobile cables.

Backings of this type based on a polyester fabric are furthermore characterized by high resistance to decomposition and to halogens as well as the absence of any plasticizers. In addition, these polyester fabric backings are abrasion-resistant and tear-resistant, yet also pliable and flexible. Adhesive tape produced therefrom can typically be employed in the temperature range between −40° C. and +125° C. that is especially relevant for automotive applications. The specially designed smooth-polished tape surface or backing surface provides a dirt-repellant and durable flexible cable harness whenever the adhesive tape is used as wrapping tape for binding cables of this type. In addition, a cable harness bound in this way is very well protected against external mechanical stresses, such as, for example sharp edges inside the automobile. The described adhesive tape is well suited, in particular, for the described automotive applications, specifically throughout the vehicle, due to the high temperature resistance of the robust backing material and excellent resistance to media.

These characteristics are also enhanced by the fact that the one or more adhesive strips are produced using a hot-melt adhesive, preferably one that is rubber-based. The use of synthetic rubber has in fact proven to be especially advantageous. This results in high adhesive strength.

As a result, the invention provides an adhesive tape whose use typically enables objects such as automobile cables to be bound easily and flexibly. The cable sets produced in this way feature easy installation and great flexibility even after the wrapping has been applied using the adhesive tape according to the invention.

The invention also relates to a tubular wrap that is used, in particular, for binding cables in automobiles. This tubular wrap is essentially composed of an adhesive tape that is wound in a spiral around the cables and adhesively attached together, as described above. When producing the tubular wrap according to the invention, the adhesive tape is adhesively attached by the one or more adhesive strips in an overlap region between the upper face of a first turn and the lower face of a second adjacent turn. In other words, the adhesive tape is wound in a spiral around the cables to be bound. Adhesive attachment of the adhesive tape is only in the overlap region of the respective adjacent turn, specifically between the upper face of the first turn and the lower face of the second adjacent turn. As a result, the adhesive tape is essentially adhesively attached to itself, and not, at least not primarily, to the cables to be bound or in general to the objects to be bound.

The configuration that is in fact usually found here is one where the one adhesive strip or the multiple adhesive strips is or are disposed in the overlap region between a back edge of the first turn and a front edge of the second adjacent turn. The front and the back edges of the respective turns are determined relative to the direction of the spiral. As a result, the inside of the adhesive tape that always faces the cable is largely free of adhesive. In any case, this is true for any starting region of the adhesive tape that is or can be used to secure the tubular wrap thus produced to the multiple cables.

In overall terms, the adhesive tape according to the invention is fundamentally characterized by the fact that the adhesive strip applied to the backing covers a maximum of up to one half the backing. In other words, the adhesive strip follows the longitudinal axis of the backing and occupies half the backing surface. This can be either the upper face of the backing and/or the lower face of the backing, or both faces of the backing. Each adhesive strip here is provided on an edge of the upper and/or lower face. In other words, the adhesive strip extends from the given edge on the upper face and/or lower face toward a center of the backing. At maximum the adhesive strip reaches from the edge to the backing centerline, or the longitudinal axis of the tape at that point.

This provides an especially advantageous approach to creating the described tubular wrap since an overlap region between the upper face of the first turn and the lower face of the second adjacent turn ensures the requisite adhesion due to the adhesive tape's being wound around the cables in a spiral configuration. In fact the one or the two adhesive strips is/are disposed only in this overlap region, with the result that each inside face of the adhesive tape facing the cable is largely free of adhesive. Only a possible starting region of the adhesive tape may provide an initial attachment to the cables to be bound by means of the adhesive strip provided there. This is not absolutely necessary, however.

The invention in any case ensures that the adhesive tape for the described application is not glued onto the cables to be bound or the cable harness, or does not adhere to them. The tubular wrap created in this way instead can be moved relative to the cables to be bound or the cable harness. This enables the cable harness of the cable set created in this way to have a level of flexibility that previously could not be achieved.

The above applies when only one adhesive strip is utilized so as to ensure mutual adhesion between the two adjacent turns in the overlap region. In most cases, however, the goal is to achieve more effective adhesion in this overlap region, however, so the approach utilizes both mutually offset adhesive strips—specifically, by locating the adhesive strips on opposite edges and on different faces of the backing. These must be viewed as the essential advantages.

The following describes the invention in more detail based on a drawing that shows only one illustrated embodiment, where:

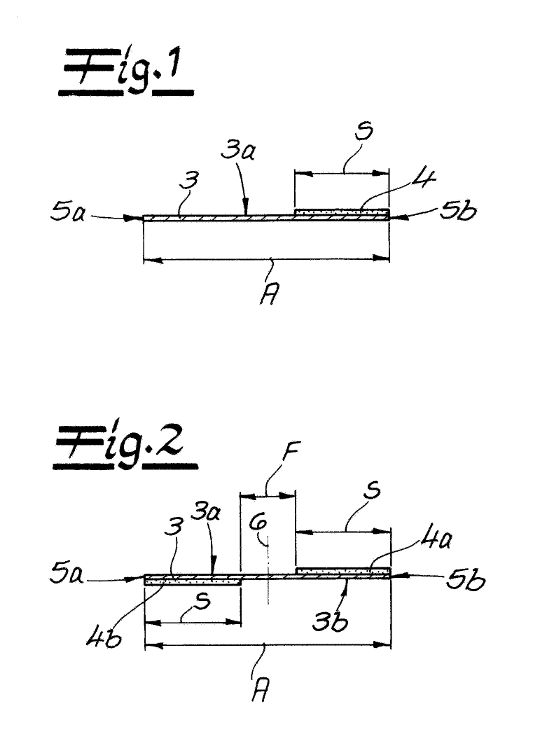

FIG. 1 shows a first embodiment of an adhesive tape according to the invention;

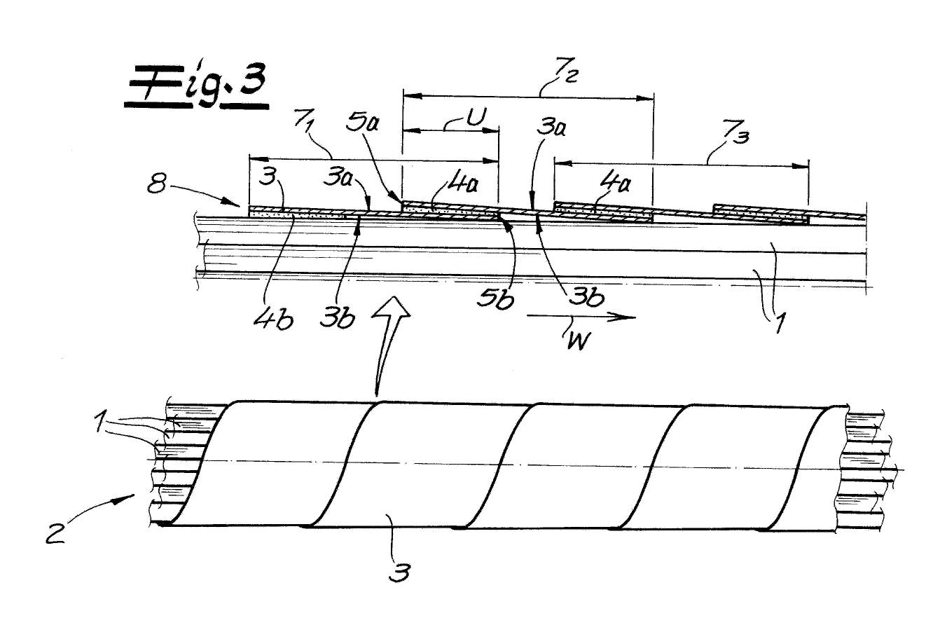

FIG. 2 shows a modified embodiment of the adhesive tape according to the invention in cross-section;

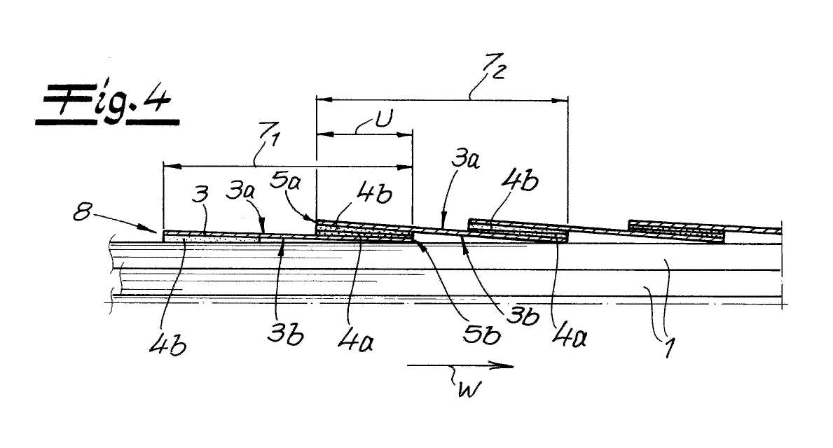

FIG. 3 shows a tubular wrap produced using the adhesive tape of FIG. 1; and

FIG. 4 shows a tubular wrap as indicated in FIG. 3 that is produced using an adhesive tape as indicated in FIG. 2.

FIGS. 1 and 2 show an adhesive tape that in this case is used as a wrapping tape for binding cables 1 in automobiles. Cables 1 may be conventional insulated cables that typically and mainly run longitudinally relative to each other and are combined together. Taken together cables 1 form a cable harness 2. The adhesive tape shown in FIGS. 1 and 2, bundles the cables 1 or cable harness 2 to combine them so that an installation-ready cable set is available for installation in an automobile after the adhesive tape is applied.

In its basic construction, the adhesive tape has a backing 3 and at least one adhesive strip 4 that is applied to the backing 3. The adhesive strip 4 in the variant of FIG. 1 is applied to one face of the backing 3, specifically on its upper face 3a. The backing 3 in the embodiment of FIG. 2 has such an adhesive strip 4 on each of its faces. In fact, one adhesive strip 4 is provided here on the upper face 3a and one additional adhesive strip 4 is provided here on the lower face 3b. For purposes of differentiating the two adhesive strips 4, the adhesive strip 4 on the upper face 3a is identified hereafter as the adhesive strip 4a while the adhesive strip 4 on the lower face 3b is given reference numeral 4b.

According to the invention, the adhesive strip 4, or 4a, 4b, occupies between 20% and 50% of the (total) surface of the respective backing face 3a, 3b. As seen in the illustrated example of FIGS. 1 and 2, the backing 3 measures a total width A of approximately 20 mm—by way of example and being not restricted to this. The adhesive strip 4 on the upper face 3a may be of a width S measuring approximately 8 mm. The adhesive strip 4 is thereby created such that in the specific example it covers approximately 40% of the surface of the associated backing face or the upper face 3a.

In the example of FIG. 2, the adhesive strip 4 or adhesive strip 4a is provided on the upper face 3a, and the adhesive strip 4b is provided on lower face 3b, and these also are of the above-referenced width S measuring 8 mm as compared with the overall width A of 20 mm for the backing 3. Adhesive strips 4; 4a, 4b each extend longitudinally and on a respective edge of the backing 3. In other words, the adhesive strip 4; 4a, 4b extend from the respective edges 5a, 5b toward a backing centerline 6. Due to the strip-shaped or rectangular aspect of the backing 3, the backing centerline 6 defines a longitudinal axis 6 of the tape. The entire adhesive tape is mirror symmetrical to this longitudinal axis 6.

It is in principle possible in the illustrated embodiment of FIG. 2 for both adhesive strips 4a, 4b to abut the same edge 5a or 5b. Typically, however, the two adhesive strips 4a, 4b end at the opposite edges 5a, 5b of the backing 3 as shown. In addition, the two adhesive strips 4a, 4b are of the same width S that in the embodiment covers approximately 40% of the surface of associated backing face 3a, 3b. Both adhesive strips 4a, 4b are produced from the same adhesive material. In fact, a hot-melt adhesive, preferably one that is rubber-based, has proven especially useful both here and also in creating the adhesive strip 4 of FIG. 1. The coating used in the example is one composed of synthetic rubber.

The two adhesive strips 4a, 4b at the opposite edges 5a, 5b of the backing 3 and on opposite faces 3a, 3b define between them a free region F of the backing 3 in cross-section. The cutaway illustration of FIG. 2 in fact clearly shows that the two adhesive strips 4a, 4b do not have any overlap in cross-section relative to each other, but are instead offset relative to each other.

This is because the two adhesive strips 4a, 4b extend from opposite edges 5a, 5b, and extend from there toward the backing centerline or backing longitudinal axis 6. Since each adhesive strips 4a, 4b is of the width S with less than 50% overlap relative to the surface of associated backing face 3a, 3b, this explains the fact that the adhesive-free region F already described above is defined between the two adhesive strips 4a, 4b. This region in the example of FIG. 2 is of a width measuring approximately 20% of the surface of the upper face 3a and of the surface of lower face 3b. This is due to the fact that respective adhesive strips 4a, 4b each occupy 40% of the surface of associated backing face 3a or 3b, and thus in total and in terms of overlap cover 80% of the backing 3. The free region F is symmetrical relative to the tape longitudinal axis 6 and itself is designed as a free-region strip.

The backing 3 is a fabric backing, and in the illustrated embodiment is a smooth-polished polyester fabric. This fabric typically is of a tape thickness measuring approximately 0.2 mm. The tear strength of the adhesive tape produced therewith is in the range of approximately 70 N/cm and higher. The elongation to tear is 10% and higher. In addition, the observed adhesive strength on steel is more than 4 N/cm. Due to the materials employed, the observed coverable temperature range is approximately −40° C. to +125° C., with the result that the adhesive tape is predestined for the above-described automotive applications.

FIGS. 3 and 4 now show a tubular wrap that has been produced using the adhesive tape of FIGS. 1 and 2 and is used for binding cables 1, or to wrap a cable harness 2 and produce the above-referenced cable set. The tubular wrap here is essentially composed of the adhesive tape of FIG. 1 or FIG. 2 that is wound in a spiral around the cables 1. The adhesive tape in this operation is adhesively attached to itself, or the individual and adjacent spiral turns 7₁, 7₂, 7₃, etc., undergo a mutual adhesive attachment. This will be described in detail.

FIG. 3 in fact first shows a tubular wrap that has been created using the adhesive tape of FIG. 1. It is evident that this adhesive tape is adhesively attached by the adhesive strip 4a disposed on the upper face 3a each time in an overlap region U between the upper face 3a of first turn 7₁ and lower face 3b of the second adjacent turn 7₂. The overlap region U in turn is delimited by the edge 5b of the backing 3 of the first turn 7₁ that is on the back in spiral direction W. Conversely, the front edge 5a of the backing 3 of the adjacent second turn 7₂ constitutes the other edge of the overlap region U.

The adhesive tape is now adhesively attached together only in this overlap region U, specifically, between the upper face 3a of the first turn 7₁ and the lower face 3b of the second adjacent turn 7₂. As a result, the inside of the adhesive tape or of the tubular wrap formed in this way is largely adhesive-free. This is because the inside of the tubular wrap is formed by the lower face 3b of the backing 3 at individual turns 7₁, 7₂, 7₃, etc. that are configured—except for a starting region—to be adhesive-free.

The adhesive strip 4b on the lower face 3b of the backing 3 is in fact evident only in an end region 8, which strip does not come from a leading turn or upper face 3a of an adjacent and leading turn. The adhesive strip 4b in the end region 8 can consequently be used to provide a weak or temporary initial attachment of the created tubular wrap.

An analogous function and similar properties are observed in the case of the adhesive tape of FIG. 2 that is employed to create a tubular wrap as indicated in FIG. 4. In this case, two adhesive strips 4a, 4b are in fact provided in the overlap region U between the back edge 5b of the first turn 7₁ and the front edge 5a of the adjacent second turn 7₂. The two adhesive strips 4a, 4b are thus produced such that the adhesive tape of FIG. 2 is provided with adhesive strips 4a, 4b that are on different backing faces 3a, 3b to create the protective wrap of FIG. 4 at opposite edges 5a, 5b of the backing 3.

The adhesive tape of FIG. 2 in fact has the described adhesive strips 4a, 4b. The adhesive strip 4a here is disposed on the upper face 3a of the backing 3 at the edge 5b of the backing 3, which edge is at the back in the spiral direction W. Conversely, the adhesive strip 4b is located on the front edge 5a of the backing 3, specifically on the lower face 3b, the edge being in the front in spiral direction W.

During the spiral wrapping of cables 1 or of cable harness 2, the two adhesive strips 4a, 4b now meet, as described, and can adhere to each other. An especially intimate bonding is provided since the two adhesive strips 4a, 4b are of the same width S. In addition, the tubular wrap of FIG. 4 is again configured such that the two adhesive strips 4a, 4b are limited in terms of their coverage to overlap region U. As a result, each inside face 3b of the adhesive tape facing the cables 1 or cable harness 2 is again adhesive-free, specifically again except for any end region 8 on which the uncovered adhesive strip 4b is located on the lower face 3b of the first turn 7₁ of the adhesive tape, which region may function to provide the initial attachment of the tubular wrap that is created in this way.

The tubular wrap in both cases can in principle be moved relative to cables 1 or cable harness 4 longitudinally or in spiral direction W and opposite thereto, as indicated in FIGS. 3 and 4. As a result, extremely high flexibility is achieved for the cable set created thereby.

Producing the adhesive tape is typically effected by cutting out the backing 3 from a strip-like material (usually in the longitudinal axis) such that multiple backings 3 are formed thereby simultaneously longitudinal parallel to one another. The adhesive strip 4 is applied simultaneously or following this. A possible approach here is one whereby first the adhesive strip 4a is defined on the upper face 3a, after which the adhesive strip 4b is defined on the lower face 3b. Typically both adhesive strips 4a, 4b are applied simultaneously to the backing 3.

It is possible, for example, to us a mask when applying the adhesive so as to achieve the partial coating of the backing 3, or of the upper face 3a or the lower face 3b. In principle, other procedures are, of course, also conceivable, and are comprised by the invention for the purpose of achieving the described surface coverage of associated backing faces 3a, 3b.

1. An adhesive wrapping tape for binding cables in automobiles, comprising a backing band and at least one adhesive strip that is applied at least to one face of the backing, wherein the adhesive strip covers between approximately 20% and 50% of the surface of the associated backing face.

2. The adhesive tape according to claim 1, wherein the adhesive strip occupies between approximately 30% and 40% of the surface of the backing face.

3. The adhesive tape according to claim 1, wherein the adhesive strip extends longitudinally of and along the edge of the backing.

4. The adhesive tape according to claim 1, wherein two adhesive strips are provided, one adhesive strip on the upper face and one adhesive strip on the lower face of the backing.

5. The adhesive tape according to claim 4, wherein the two adhesive strips extend from the same edge.

6. The adhesive tape according to claims 4, wherein the two adhesive strips extend from opposite edges.

7. The adhesive tape according to claim 4, wherein the two adhesive strips are of an essentially the same width.

8. The adhesive tape according to claim 1, wherein the two adhesive strips are produced from the same adhesive material.

9. The adhesive tape according to claim 4, wherein the two adhesive strips that are on opposite edges on different backing faces delimit between them in cross-section a free region of the backing that is preferably provided symmetrically relative to a longitudinal axis of the tape.

10. The adhesive tape according to claim 1, wherein the backing is a fabric backing.

11. The adhesive tape according to claim 1, wherein the backing has at least in certain regions a surface that is smooth-polished on one face or both faces.

12. The adhesive tape according to claim 1, wherein the adhesive strip is produced from a hot-melt rubber-based adhesive.

13. A tubular wrap for binding cables in automobiles, composed essentially of an adhesive tape that is wound in a spiral around the cables as well as adhesively attached together according to claim 1.

14. The tubular wrap according to claim 13, wherein the adhesive tape is adhesively attached by the adhesive strip in an overlap region between the upper face of a first turn and the lower face of a second adjacent turn.

15. The tubular wrap according to claim 13, wherein the adhesive strip is disposed in an overlap region between a back edge of the first turn and a front edge of the second adjacent turn, with the result that the inside face of the adhesive tape facing the cables is largely free of adhesive.
